(19) United States
(12) Patent Application Publication
(10) Pub. No.: US 2004/0164179 A1
(43) Pub. Date: Aug. 26, 2004

(54) Sprinkler spacer system

(76) Inventor: J. Craig Corbett, Lyman, WY (US)

Correspondence Address: Dean P. Edmundson, P.O. Box 179, Burton, TX, 77835, US

(21) Appl. No.: 10/626,910

(22) Filed: Jul. 25, 2003

Related U.S. Application Data
(60) Provisional application No. 60/402,454, filed on Aug. 9, 2002.

(51) Int. Cl. B05B 15/06

(52) U.S. Cl. 239/276; 239/273; 239/200; 239/201; 239/288

(57) ABSTRACT

A support system for supporting a sprinkler head which is connected to a water supply line by means of a flexible pipe. The support system includes a spacer body having inner and outer portions and is capable of being attached to a sprinkler head. An elongated stake member is carried by the spacer body and extends downwardly from the spacer body to provide lateral support to the spacer body and the sprinkler head when the stake member is inserted into the ground.

### CROSS-REFERENCE TO RELATED APPLICATION

This application is based upon, and claims priority from, my Provisional Application No. 60/402,454, filed Aug. 9, 2002.

### FIELD OF THE INVENTION

This invention relates to sprinkler systems commonly used for sprinkling lawns or other landscaped areas. More particularly, this invention relates to installation techniques for sprinkler systems.

### BACKGROUND OF THE PRIOR ART

Typical sprinkler systems used for lawns and other landscaped areas include water supply lines which are placed below ground and extend from a main supply pipe to each sprinkler head. The sprinkler head extends upwardly to the upper surface of the ground. Typical sprinkler heads are of the “pop-up” style which extend upwardly above the grass when pressure is applied to the water in the supply line, and then the sprinkler head retracts when it is no longer in use. The top of the sprinkler head remains exposed at ground level.

In some installations, the sprinkler head is connected to the water supply pipe with a flexible pipe. Although this enables the installer to more easily position the sprinkler head in a desired place, the flexible pipe provides little, if any, support to the sprinkler head (either lateral or vertical support). As a result, when soil is filled in around the sprinkler head, the sprinkler head can tilt to one side or the other, and the sprinkler head can also sink downwardly. When the sprinkler head is too close to a sidewalk, curb or other such object, the spinning metal blade of an edger can irreparably damage any sprinkler head which is too close to sidewalk, curb, etc. Then the sprinkler head must be replaced, at considerable time and expense.

U.S. Pat. No. 5,102,048 (Bohnhoff) describes an irrigation head support which is a circular mat with a plurality of concentric circular ribs connected by a plurality of radially extending ribs. There is an opening in the center of the mat for receiving an irrigation head. The mat also includes a plurality of upwardly extending rings which are spaced around the outer portion of the mat. The upper surface of such rings is to be placed at ground level when the mat and the irrigation head are installed (e.g. on a golf course). The purpose of the guard is said to be for protecting an irrigation head from vehicle tires and for preventing erosion of the soil surrounding the head. The circular mat was not designed or intended for use in connection with obtaining the proper spacing of sprinkler heads in lawns from sidewalks, curbs, etc. where edgers are used. Further, the circular mat was not designed for providing support to a sprinkler head attached to a flexible pipe.

U.S. Pat. No. 5,678,353 (Tsao et al.) describes a grass guard for preventing growth of any vegetation around a perimeter of an object (e.g. a sprinkler head). The grass guard is composed of two layers. The top layer is a plastic sheet simulating grass, and the bottom layer is made of heavy grit bonded into a uniform body with a polymer. The grass guard is shown as a circular mat which has a central opening for a sprinkler head to fit through. The grass guard is intended for use around existing sprinkler heads. Where a sprinkler head is already located adjacent to a sidewalk, for example, one side of the grass guard can be cut away. There is no description in the patent regarding use of the grass guard during installation of a sprinkler head to maintain proper position of the sprinkler head, and even if the grass guard was used, a lawn edger would still hit it while edging. Further, the patent does not describe use of the mat to provide lateral and vertical support to a sprinkler head connected to a flexible pipe.

U.S. Pat. No. 6,186,416 (Jones) describes a trim ring for use around a lawn sprinkler to discourage grass growth around it and to protect the sprinkler by indicating its location. The trim ring includes two complementary plates, each having a notch which, when assembled, forms a central aperture fitting around a sprinkler body. The overlapped plates are then secured to each other by screws. The patent does not describe use of the trim ring for positioning sprinkler heads during installation next to a sidewalk or curb, etc. Further, the patent does not refer to providing lateral or vertical support to a sprinkler head.

U.S. Pat. No. 4,146,181 (Soos) describes a guard ring for a lawn sprinkler. The guard ring includes a central sleeve for surrounding the upper portion of the sprinkler head, and a frustoconical skirt extends outwardly and downwardly from the upper edge of the sleeve. A plurality of stabilizing fins extends downwardly and outwardly from the periphery of the skirt. The guard ring is for protecting the sprinkler head from lawn mowers which drive over the sprinklers. The patent does not describe use of the guard ring for positioning of sprinkler heads adjacent to sidewalks, curbs, etc. Further, the patent does not describe providing lateral and vertical support to a sprinkler head connected to a flexible pipe.

U.S. Design Pat. D410,731 (Bowman et al.) shows a sprinkler head guard which appears to be a circular disk with an off-set opening extending through it. The apparent purpose of the guard is to protect the sprinkler head from the activity of conventional lawn mowers.

There has not heretofore been provided a system for effectively supporting a sprinkler head in a lawn or other landscaped area where the sprinkler head is attached to the water supply line with a flexible pipe.

### SUMMARY OF THE INVENTION

In accordance with the present invention there is provided a system for supporting a sprinkler head in the ground when the sprinkler head is attached or connected to a flexible pipe. The support system also serves as a spacer to prevent the sprinkler head from being positioned too close to a sidewalk, curb, etc. The support system preferably involves the use of a spacer or guide member which can be attached to the sprinkler body and which extends laterally outwardly an appropriate distance so that when the sprinkler head is installed the sprinkler head can be easily positioned a defined distance from a sidewalk, curb, etc. The spacer or guide prevents the sprinkler head from being placed too close to the sidewalk, curb, etc.

In one embodiment, the support system preferably includes opposing resilient fingers which are adapted to grip or fit partially around the tubular body of a sprinkler head. The support system also preferably includes a vertically extending tab which extends upwardly (and preferably downwardly also) a predetermined distance to prevent the support system from being positioned too high on the sprinkler body. It is preferred that the main portion of the support/spacer body be positioned at least about 1.5 to 3 inches below the rim of the sprinkler head so that the spacer is not contacted by a conventional lawn edger which is used to cut grass along a sidewalk, curb, etc.

The support system also includes an elongated member or stake (preferably tapered along its length) which is carried or supported by the support/spacer body. The elongated stake extends downwardly from the support/spacer body so as to provide lateral and vertical support to the sprinkler head. Preferably the stake member extends a few inches below the lower end of the sprinkler head so that the stake member extends well into the ground during installation of the sprinkler head. The stake member keeps the sprinkler head in a vertical position and prevents the sprinkler head from leaning to one side before fill dirt can be placed properly around the sprinkler head and compacted.

The support system accordingly provides lateral and vertical support to the sprinkler head, yet it does not interfere with conventional lawn edging operations. The support system enables water, fertilizer, etc. to flow through it. Grass is able to grow upwardly through openings in the body.

Other advantages and features of the system of this invention will be apparent from the following detailed description and accompanying drawings.

### BRIEF DESCRIPTION OF THE DRAWINGS

The invention is described in more detail hereinafter with reference to the accompanying drawings wherein:

FIG. 1 is an elevational view showing the manner in which a conventional sprinkler head is installed when connected to a flexible pipe;

FIG. 2 is a perspective view showing a preferred support system of this invention attached to a sprinkler head; and

FIG. 3 is an elevational view showing the use of the support system of FIG. 2 when installing a sprinkler head.

### DETAILED DESCRIPTION OF THE INVENTION

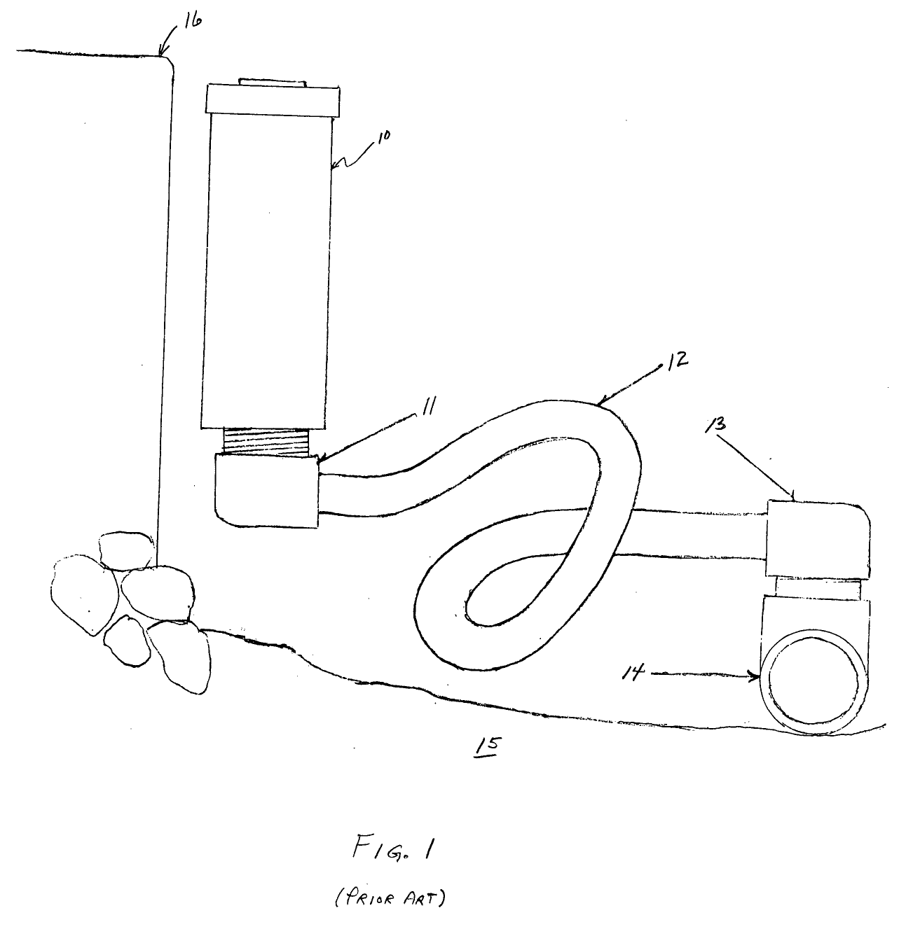

FIG. 1 shows a conventional sprinkler head 10 attached at its lower end to a flexible hose or pipe 12 with a coupler or connector 11. The flexible pipe is connected to a water supply line 14 through coupler 13. The sprinkler head is intended to be positioned in close proximity to a sidewalk, curb, etc. 16. As will be readily noted from the drawing, there isn't anything providing lateral or vertical support for the sprinkler head. The person installing the sprinkler head or completing the landscaping must hold the sprinkler in the desired position while placing dirt or soil around the sprinkler head and then compacting the soil around the head until the sprinkler head is supported. Often times, however, insufficient packing of the soil occurs, or the sprinkler head is tilted, or it is placed too close to the edge of the sidewalk 16.

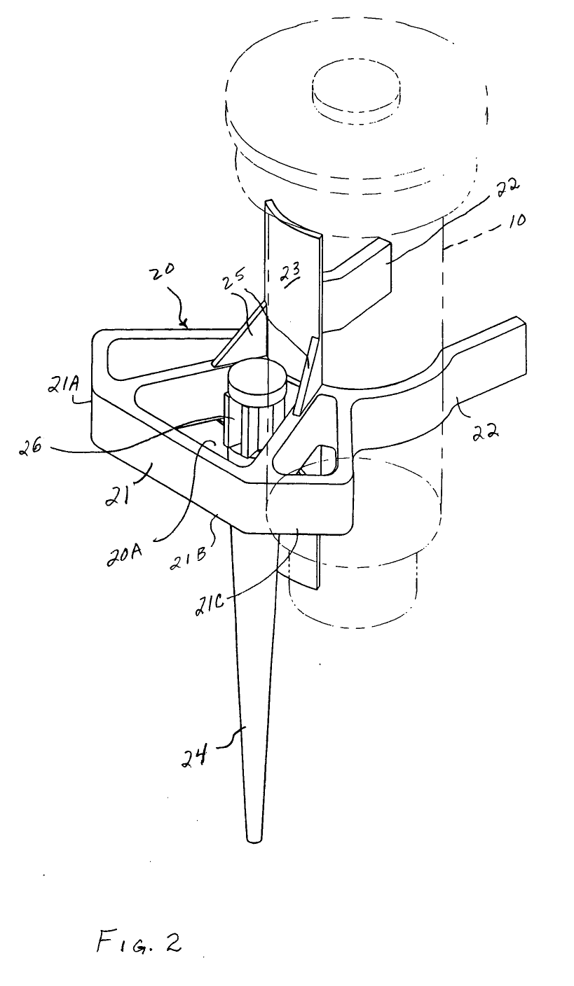

FIG. 2 illustrates a preferred embodiment of the support system 20 of the invention in combination with a conventional sprinkler head 10. The support system includes a body portion 21, opposing finger grips 22, a tab member 23 (which extends upwardly and downwardly from the body portion), and an elongated stake member 24 carried by the body member.

The body portion 21 preferably includes openings 20A through it to enable grass to grow through the body portion, further stabilizing the assembly, and allowing water, fertilizer, etc. to flow downwardly through the spacer to support the grass. The opposing grips 22 are resilient so that they are easily urged apart in order for them to be slipped or snapped onto the cylindrical body of the sprinkler head 10. The resilient grips then hold the spacer onto the sprinkler head and also allow the body portion to move vertically or rotationally relative to the sprinkler head after it has been attached.

The vertical tab 23 prevents the body portion 21 from being attached too high on the sprinkler body. This assures that the body portion 21 will be located at a sufficient depth below the surface of the ground (e.g. about 1.5 to 2 inches) so that it will not be contacted by the spinning blade of a lawn edger during normal use. The vertical tab preferably extends both upwardly and downwardly from the body portion 21 about 1.5 to 3 inches. Gussets 25 may be included between the tab 23 and the body portion 21 to provide additional structural support to the tab.

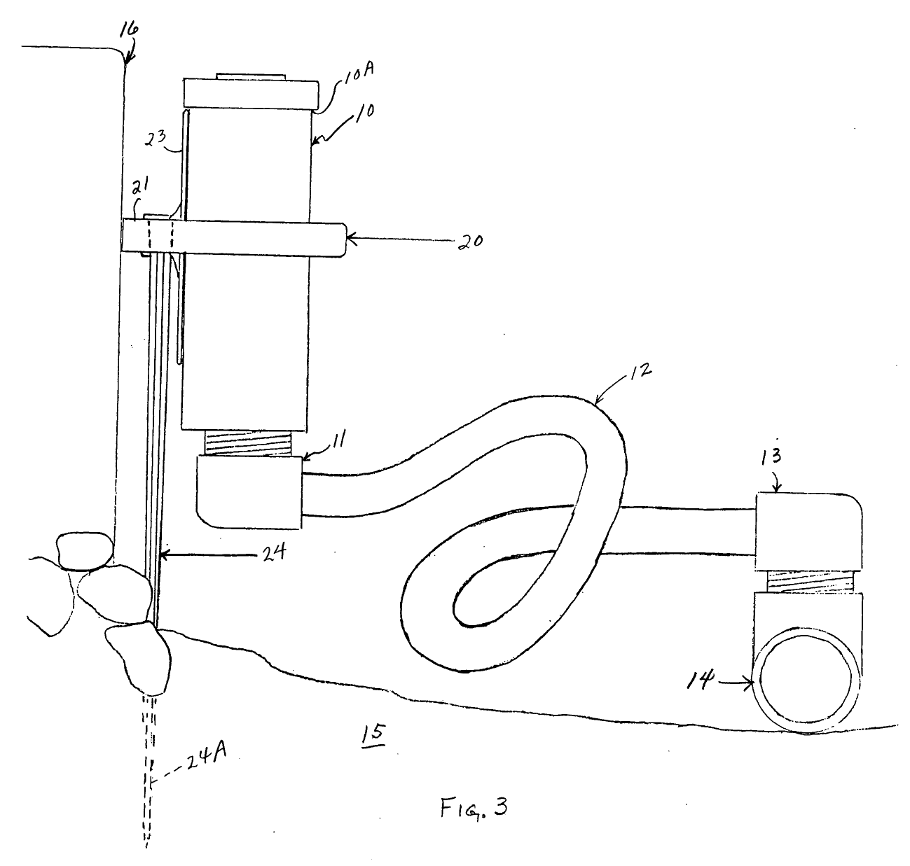

An elongated stake member 24 is carried by the body portion 21 and it extends downwardly a distance of several inches so that the lower end of the stake can be pushed into the ground and thereby provide lateral and vertical support to the body portion 21 and the sprinkler head 10 during installation of the sprinkler head in a lawn or other landscaped area. See FIG. 3. Preferably the stake member is tapered along its length, as illustrated in the drawings.

The stake member can be an integral part of the body portion 21, or it can be a separate component which is inserted through a vertical opening in the body portion. In the embodiment shown in the drawings, the stake member is a separate component which has been inserted through an opening in ribbed portion 26 of body member 21 (where the stake member is held in frictional engagement with the body member). A variety of different attachment means can be used to attach the stake member to the body portion of the spacer, e.g. spring clip fingers, an annular ring through which the stake is inserted, etc.

Preferably, the body member 21 includes three exterior or outer vertical surfaces or edges 21A, 21B and 21C. One or more of these vertical surfaces or edges are used to determine the proper placement of a sprinkler head next to a sidewalk, curb, etc. The vertical edges prevent the sprinkler head from being positioned too close to the edge of a sidewalk, for example, or too close to the intersection of sidewalks or the like.

FIG. 3 illustrates use of the system for supporting a conventional sprinkler head 10 (where the sprinkler head is connected to a flexible pipe 12 via coupler 11). The flexible pipe 12 is attached to a water supply line 14 through coupler 13. The stake member 24 (carried by body member 21) extends downwardly (generally parallel to the axis of the sprinkler head) several inches so that the lower end 24A of the stake member extends into the ground 15 sufficiently far to provide vertical and lateral support to the sprinkler head 10. As shown, the body member 21 is positioned in contact with (or in close proximity to) the vertical edge of a sidewalk or curb 16. The body portion 21 accordingly prevents the sprinkler head from being too close to the sidewalk or curb. The sprinkler head 10 includes a rim 10A near its upper end, and the tab 23 contacts the underside of that rim. In this manner, the tab 23 prevents the body 21 from being moved any further upwardly relative to the sprinkler head body.

The support system of the invention thus enables a sprinkler head to be easily and simply positioned and supported during installation. Because the sprinkler head is properly supported, soil or dirt can be placed around the sprinkler head and compacted without the sprinkler head moving too close to the sidewalk or curb. The support system also keeps the sprinkler head from leaning to one side or the other.

The support 20 of this invention can be composed of any desired material. Normally it is composed of a plastic material because of economics and because it is light in weight. Various conventional plastics are suitable (e.g. nylon, PVC, acrylic, carbonate, etc.). Metal, wood, ceramic, fiberglass or composite materials could also be used. The sizing and styling of the support could also vary and it can be made to accommodate any diameter of sprinkler head.

Other variants are possible without departing from the scope of this invention.

What is claimed is:

1. A support system for supporting a sprinkler head in the ground, the system comprising:
(a) a spacer body having an outer peripheral portion and an inner portion;
(b) attachment means for attaching said spacer body to said sprinkler head; and
(c) an elongated stake member carried by, and extending downwardly from, said spacer body; wherein said stake member provides lateral support to said spacer body and said sprinkler head in the ground.

2. A support system in accordance with claim 1, wherein said stake member is detachable from said spacer body.

3. A support system in accordance with claim 2, wherein said spacer body includes an opening which is sized to receive said stake member.

4. A support system in accordance with claim 1, wherein said stake member is tapered along its length.

5. A support system in accordance with claim 1, wherein said outer peripheral portion and said inner portion are joined by spaced vertical ribs which define openings through said spacer body.

6. A support system in accordance with claim 1, wherein said outer peripheral portion extends outwardly a predetermined distance so as to enable said sprinkler head to be positoned adjacent to a sidewalk or curb with a spacing at least equal to said predetermined distance.

7. A support system in accordance with claim 1, wherein said attachment means comprises resilient finger grips for gripping said sprinkler head.

8. A support system in accordance with claim 1, wherein said sprinkler head includes an outwardly extending rib, and wherein said spacer body further comprises a vertical tab member adjacent to said inner portion of said spacer body; wherein said vertical tab member limits the extent of upward travel of said spacer body relative to said sprinkler head when said tab member encounters said outwardly extending rib.
